(19) United States
(12) Patent Application Publication
(10) Pub. No.: US 2012/0100333 A1
(43) Pub. Date: Apr. 26, 2012

(54) RUBBING CLOTH FOR RUBBING PROCESS OF ALIGNMENT FILM

(75) Inventors: Jiaoming LU, Beijing (CN); Yongzhi SONG, Beijing (CN)

(73) Assignee: BOE TECHNOLOGY GROUP CO., LTD., Beijing (CN)

(21) Appl. No.: 13/276,486

(22) Filed: Oct. 19, 2011

(30) Foreign Application Priority Data
Oct. 20, 2010 (CN) 201010519990.1

(51) Int. Cl. B32B 33/00

(52) U.S. Cl. 428/89; 428/90

(57) ABSTRACT

A rubbing cloth for the rubbing an alignment film is provided, which comprises a rubbing base film capable of being attached onto an external surface of a rubbing alignment roller; and rubbing hairness fixedly provided on the rubbing base film. A surface faulted by tips of all the rubbing hairness on the rubbing base film for contacting with a surface of the alignment film is in a serration or circular arc shape along a rubbing direction when the rubbing cloth is flattened; and both the tips of all the rubbing hairness on the rubbing film and the tips of the hairness at the two ends of the rubbing base film are continuously connected when the rubbing cloth forms an entire circle.

### BACKGROUND

The disclosed technology relates to a rubbing cloth for the rubbing process of the alignment film.

Thin film transistor liquid crystal displays (TFT-LCDs) have been widely used for monitors, TV sets, notebook computers and the like. A TFT-LCD generally includes an array substrate and a color filter substrate, which are arranged opposite to each other with a liquid crystal layer interposed therebetween. The TFT-LCD utilizes the electric field to control the deflection of liquid crystal molecules to change the gray scale of display and thereby achieve desired display effect. In order to deflect liquid crystal molecules according to a predetermined direction, it would be better to arrange liquid crystal molecules in order initially. The conventional technology is to coat an alignment film, which is capable of performing pre-alignment to liquid crystal molecules, on the inner surfaces of both the color filter substrate and the array substrate.

The conventional method employs a rubbing process to treat the alignment film, and this method may include the following two steps. The first step is to coat an alignment film, which is polyimide (PI) in most cases, on each of the color filter substrate and the array substrate; the second step is to use a rubbing cloth to perform a rubbing treatment on the alignment films to further form grooves in a direction which have an effect of anchoring with respect to liquid crystal molecules, arranging liquid crystal molecules in the direction.

FIG. 1 is a schematic structure view of a conventional rubbing cloth for rubbing process on alignment film. As shown in FIG. 1, the rubbing cloth includes a rubbing base film 12 and rubbing hairness 13. The rubbing base film 12 is attached on a rubbing alignment roller 11. The rubbing hairness 13 is provided in uniform height along the direction of the length of the rubbing base film 12 for contacting with the alignment film to be rubbed, to generate grooves arranged in a certain direction on the surface of the alignment film such that the liquid crystal molecules on the alignment film can be arranged in line with these grooves.

### SUMMARY

An embodiment of the disclosed technology provides a rubbing cloth for rubbing an alignment film, comprising a rubbing base film capable of being attached onto an external surface of a rubbing alignment roller; and rubbing hairness fixedly provided on the rubbing base film. A surface formed by tips of all the rubbing hairness on the rubbing base film for contacting with a surface of the alignment film is in a serration or circular arc shape along a rubbing direction when the rubbing cloth is flattened; and both the tips of all the rubbing hairness on the rubbing film and the tips of the hairness at the two ends of the rubbing base film are continuously connected when the rubbing cloth forms an entire circle.

Further scope of applicability of the disclosed technology will become apparent from the detailed description given hereinafter. However, it should be understood that the detailed description and specific examples, while indicating preferred embodiments of the disclosed technology, are given by way of illustration only, since various changes and modifications within the spirit and scope of the disclosed technology will become apparent to those skilled in the art from the following detailed description.

### BRIEF DESCRIPTION OF THE DRAWINGS

The disclosed technology will become more fully understood from the detailed description given hereinafter and the accompanying drawings which are given by way of illustration only, and thus are not limitative of the disclosed technology and wherein:

FIG. 1 is a schematic structure view of a conventional rubbing cloth for rubbing process on an alignment film;

FIG. 2 is a schematic structure view of a first embodiment of a rubbing cloth for rubbing process on an alignment film of the disclosed technology;

FIG. 3 is a schematic structure view of the first embodiment of a rubbing cloth for rubbing process on an alignment film of the disclosed technology;

FIG. 4 is a schematic structure view of a second embodiment of a rubbing cloth for rubbing process on an alignment film of the disclosed technology;

FIG. 5 is a schematic structure view of the second embodiment of a rubbing cloth for rubbing process on an alignment film of the disclosed technology;

FIG. 6 is a schematic structure view of a third embodiment of a rubbing cloth for rubbing process on an alignment film of the disclosed technology;

FIG. 7 is a schematic structure view of the third embodiment of a rubbing cloth for rubbing process on an alignment film of the disclosed technology;

FIG. 8 is a schematic structure view of a fourth embodiment of a rubbing cloth for rubbing process on an alignment film of the disclosed technology;

FIG. 9 is a schematic structure view of the fourth embodiment of a rubbing cloth for rubbing process on an alignment film of the disclosed technology; and

FIG. 10 is a schematic structure view of a fifth embodiment of a rubbing cloth for rubbing process on an alignment film of the disclosed technology.

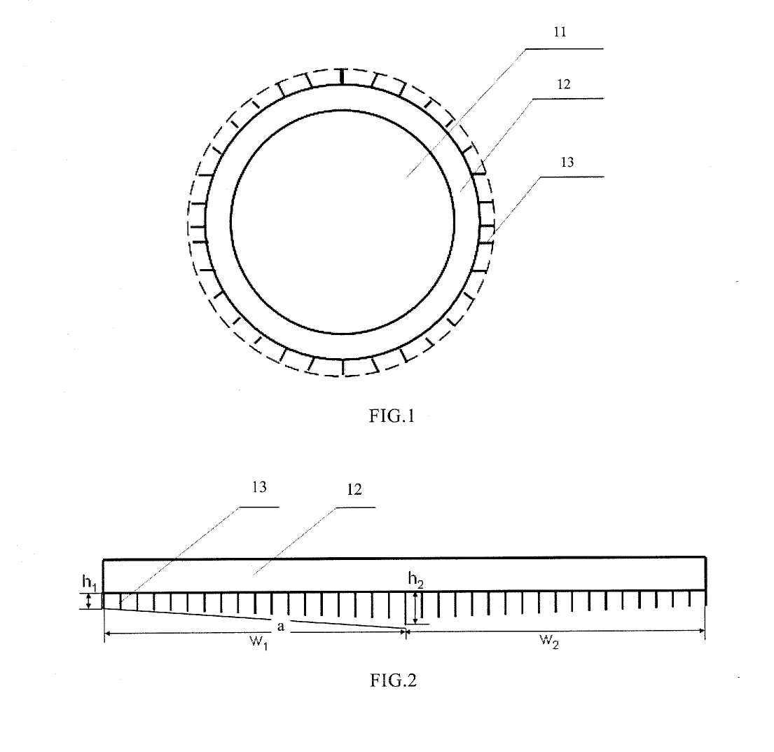

### DETAILED DESCRIPTION

In order to make the purpose, technical solutions and advantages of the disclosed technology more clearly, the embodiments of the disclosed technology in combination with the drawings will be described clearly and integrally below, and it is obviously that the described embodiments are a part of the embodiments of the disclosed technology, but not all of them. Based on these embodiments of the disclosed technology, all the other embodiments achieved by those skilled in the art from the teaching without creative work fall within the protection scope of the disclosed technology.

However, it is found that the rubbing cloth for the rubbing process of the alignment film of the prior art has the following technical defects: in the rubbing process, in order to enhance the anchoring force of the alignment film to liquid crystal, the manner generally used is to increase the contact length of the rubbing hairness with the alignment film; but the increase of the contact length of the rubbing hairness with the alignment film will causes the decrease of the uniformity of the liquid crystal alignment, which would appear as horizontal rubbing mura when presenting in the final production and decrease the quality of display.

The embodiments of the disclosed technology provide a rubbing cloth for rubbing process of alignment film. The rubbing cloth comprises a rubbing base film and rubbing hairness fixedly provided on the rubbing base film, with the rubbing base film is used to be attached on the external surface of a rubbing alignment roller. The surface (or enveloping surface) formed by the tips of all the rubbing hairness on the rubbing base film for contacting with the surface of the alignment film is in a serration shape or a circular arc shape along the direction of rubbing; and both the tips of all the rubbing hairness and the tips of the rubbing hairness at the two ends of the rubbing base film are continuously connected. The embodiments of the disclosed technology can enhance the rubbing strength and improve the uniformity of the rubbing alignment simultaneously, has rubbing continuity to the alignment film, and achieve a good effect of rubbing alignment.

The technical solutions of the disclosed technology will be further described in detail by means of the following drawings and embodiments.

### Embodiment 1

FIG. 2 is a schematic structure view of the first embodiment of a rubbing cloth for a rubbing process on an alignment film of the disclosed technology. As shown in FIG. 2, the rubbing cloth of this embodiment includes a rubbing base film 12 and rubbing hairness 13.

In use, the rubbing base film 12 is attached to the external surface of a rubbing alignment roller, and functions to fix the rubbing hairness 13. The rubbing hairness 13 is adapted to contact with the surface of the alignment film to be treated and to perform the rubbing treatment on the surface of the alignment along with the rotation of the rubbing alignment roller, so as to form grooves having a certain alignment direction where the alignment film has been rubbed by the rubbing hairness 13. Typically, examples of the materials for the rubbing hairness 13 may be artificial fibers or cotton velvets. Artificial fibers are of good elasticity and have relatively good rubbing strength even though the contact length with the alignment film is short; cotton velvets are characterized in that a plurality of rubbing hairness, which can contact the alignment simultaneously, may be provided, and the precision of alignment is high.

In the rubbing cloth of the embodiment, the rubbing base film 12 has a uniform thickness, and the height of rubbing hairness 13 (with respect to a bottom surface of the rubbing cloth) gradually decreases from the middle to both sides. In the gradual change described above, the tips of all the rubbing hairness 13 on the rubbing base film 12 are continuously connected. Herein, “continuously connected” refers to that, when the rubbing cloth is attached to a rubbing alignment roller and forms an enclosed circle, the heights of the tips of adjacent portions of the rubbing hairness 13 are smoothly changed without a sudden disconnection, and moreover, the tips of the rubbing hairness 13 at the two ends of the rubbing base film is also smoothly changed such that the surface (enveloping surface) formed by the tips of all the rubbing hairness 13 on the entire rubbing base film on the roller is a smooth transition surface, without a sudden change in height.

In this embodiment, the surface formed by the tips of all the rubbing hairness on the rubbing base film appears as a serration along a rubbing direction with a convex in the middle as shown in FIG. 2 when the rubbing cloth of the embodiment is flattened. The rubbing direction is the direction in which the rubbing base film is attached to the rubbing roller. The serration may be formed of a plurality inclined surfaces; and in the case of one cycle shown in FIG. 2, the serration is formed of two inclined surfaces which are obtained with the gradual decrease of the height of the rubbing hairness 13 from the middle section respectively to the two sides of the rubbing base film. The height of the rubbing hairness changes gradually, i.e., the height of the rubbing hairness 13 changes smoothly and connects continuously, thus there is no sudden change shape which is irregular and has significant difference along the length.

Particularly, the height of the rubbing hairness may appear in periodical change in the rubbing direction. The number of period “n” may be more than or equal to 1 (n is an integer). For example, the instance of one period is shown in FIG. 2, and the rubbing hairness 13 includes two sections having a length w1 and w2 respectively, where w1=w2. The height of the rubbing hairness 13 decreases gradually from the middle to each side, forming an inclined plane. Moreover, the rubbing hairiness 13 of the section w1 and that of the section w2 appear in mirror symmetry. For example, in section w1, the height of the rubbing hairness 13 decreases progressively from right to left; the height of the rubbing hairness 13 at the rightmost side is h2, the height of the rubbing hairness 13 at the leftmost side is h1, and h1 is less than h2.

Further, the difference between the maximum value and minimum value of the height of the rubbing hairness 13 in the embodiment is less than or equal to 2 mm, i.e., |h2−h1|≦2 mm. Additionally, in the section w1, the height of the rubbing hairness 13 increases progressively form left to right, causing the tips of the rubbing hairness 13 to form a inclined plane with a inclined angle of “a” with respect to the bottom surface of the rubbing cloth. Since a significant height difference between the highest and shortest of the rubbing hairness could have a disadvantage effect on rubbing, the incline angle “a” described above can be determined within 10 degree, i.e., 0°≦a≦10°, to prevent the significant gradient of the inclined plane from affecting the rubbing alignment and to ensure a good rubbing effect. Here, a=arctg(h2−h1)/L, and L is a half of the length of the rubbing base film 12.

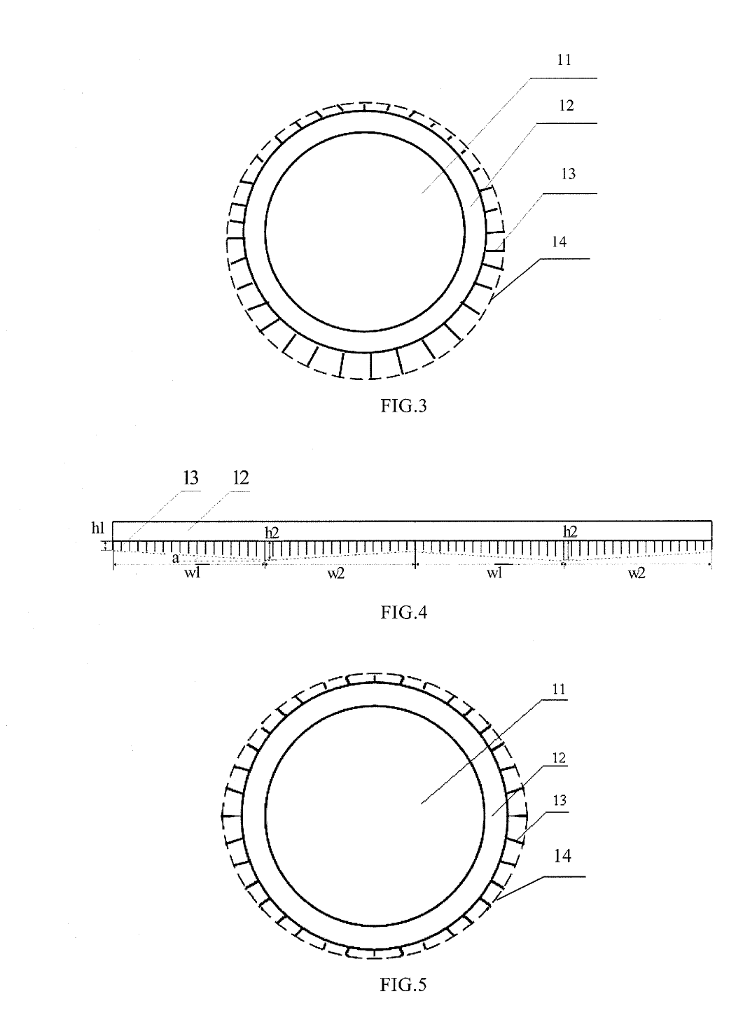

FIG. 3 is a schematic structure view of the first embodiment of a rubbing cloth for rubbing process on an alignment film of the disclosed technology. As shown in FIG. 3, i.e., the rubbing cloth changed in a period shown in FIG. 2 is wrapped on the rubbing alignment roller 11 as an entire circle. The rubbing film 12 of the rubbing cloth is attached on the external surface of the rubbing alignment roller 11. It can be seen in FIG. 3 that, after the rubbing cloth is attached on the rubbing alignment roller 11, the tips of the rubbing hairness for contacting with the alignment film to be rubbed are continuous in height, and thus the surface 14 formed by the tips of the rubbing hairness 13 on the rubbing cloth is a smoothly continuous surface, but not a ragged surface. That is, the height of the tips of adjacent rubbing hairness 13 is smoothly transitional without a sudden change. Moreover, the height of tips of the rubbing hairness on the connected two ends of this rubbing cloth is also smoothly transitional, forming a continuous surface. The surface of the entire rubbing alignment roller 11 with the rubbing cloth looks like a smooth surface without a sudden change in the height of the tips of the hairness, with which a relatively good rubbing effect can be obtained.

When the rubbing cloth of this embodiment is used, the rubbing alignment roller rotates. With the rotation of the roller, the rubbing cloth rotates to perform the rubbing process on the surface of the alignment film which contacts with the rubbing cloth. When higher (i.e., longer) rubbing hairness 13 contacts with the alignment film, the contact length with the alignment is relatively greater, thereby a higher rubbing strength may be achieved to enhance anchoring force for retaining the liquid crystal; when shorter rubbing hairness 13 contacts with the alignment film, the contact length with the alignment is less, thereby a relatively better alignment uniformity can be achieved. With the rubbing cloth of this embodiment, the purposes of increasing the rubbing strength and enhancing the alignment uniformity are achieved simultaneously. Moreover, the surface 14 formed by the tips of the rubbing hairness 13 of this embodiment is a continuous surface, which can perform a continuous rubbing on the alignment film, to ensure the uniform distribution of the rubbing strength and the alignment uniformity on the entire glass substrate in process.

Furthermore, the height of the rubbing hairness of this embodiment decreases gradually from the middle to the two sides of the rubbing base film. It is not limited to this in the implementation; for example, it may also be that the height of the rubbing hairness 13 increases gradually from the middle to the two sides of the rubbing base film 12, such that the tips of the rubbing hairness 13 become higher from the middle to the two sides of the rubbing base film 12 symmetrically.

The rubbing cloth of this embodiment for the alignment film rubbing process, with the tips of the rubbing hairness in a serration shape along the direction of rubbing and the continuous connection of the height of the tips of the rubbing hairness at the two ends of the rubbing base film, avoids the decrease of the uniformity of the alignment direction caused by the increase of the contact length of the rubbing hairness with the alignment film, and enhances the rubbing strength and the rubbing uniformity simultaneously. Moreover, the continuous uniformity of the rubbing effect can be ensured with the continuity of the surface, the contrast and the quality of picture can be enhanced, and the utilization ratio of the rubbing cloth can enhanced.

### Embodiment 2

FIG. 4 is a schematic structure view of the second embodiment of a rubbing cloth for the rubbing process on an alignment film of the disclosed technology, and FIG. 5 is a schematic structure view of the second embodiment of a rubbing cloth for the rubbing process on an alignment film of the disclosed technology.

This embodiment is different from the first embodiment. The first embodiment shows an instance in which the height of the rubbing hairness 13 in the rubbing cloth includes only one change period along the rubbing direction; in the rubbing cloth shown in FIG. 4 and FIG. 5, the height of the rubbing hairness 13 includes a plurality of change periods along the rubbing direction, for example, two periods are shown in this embodiment, each of which may be configured similarly to the first embodiment.

In this embodiment, it can be seen from the FIG. 4 and FIG. 5, when the rubbing cloth of this embodiment is flattened, the enveloping surface formed by the tips of all the rubbing hairness 13 on this rubbing base film 12 is also in a serration; this serration comprises a plurality of inclined planes; moreover, the height of the rubbing hairness 13 decreases gradually, increases gradually again, changing gradually, such that the height between the adjacent portions of rubbing hairness 13 would not change suddenly and the surface 14 formed by the tips of the rubbing hairness is continuous. After this rubbing cloth is attached to a rubbing alignment roller 11, the tips of all the rubbing hairness 13 forms a continuous surface; moreover, the rubbing hairness 13 of the connected two ends of this rubbing base film 12 also has the tip height that changes gradually, so as to also prevent a sudden change of tip height from occurring at the connected ends. The surface 14 formed by the tips of the rubbing hairness described above is continuously connected, which may make the rubbing effect better.

The rubbing cloth of this embodiment for the rubbing processing of alignment film, with the tips of the rubbing hairness in a serration along the rubbing direction and the continuous connection of the height of the tips of the rubbing hairness at the two ends of the rubbing base film, avoids the decrease of the uniformity of the alignment direction caused by the increase of the contact length of the rubbing hairness with the alignment film, and enhances the rubbing strength and the rubbing uniformity simultaneously. Moreover, the continuous uniformity of the rubbing effect can be ensured by the continuity of the surface, the contrast and the quality of picture can be enhanced, and the utilization ratio of the rubbing cloth can be enhanced.

### Embodiment 3

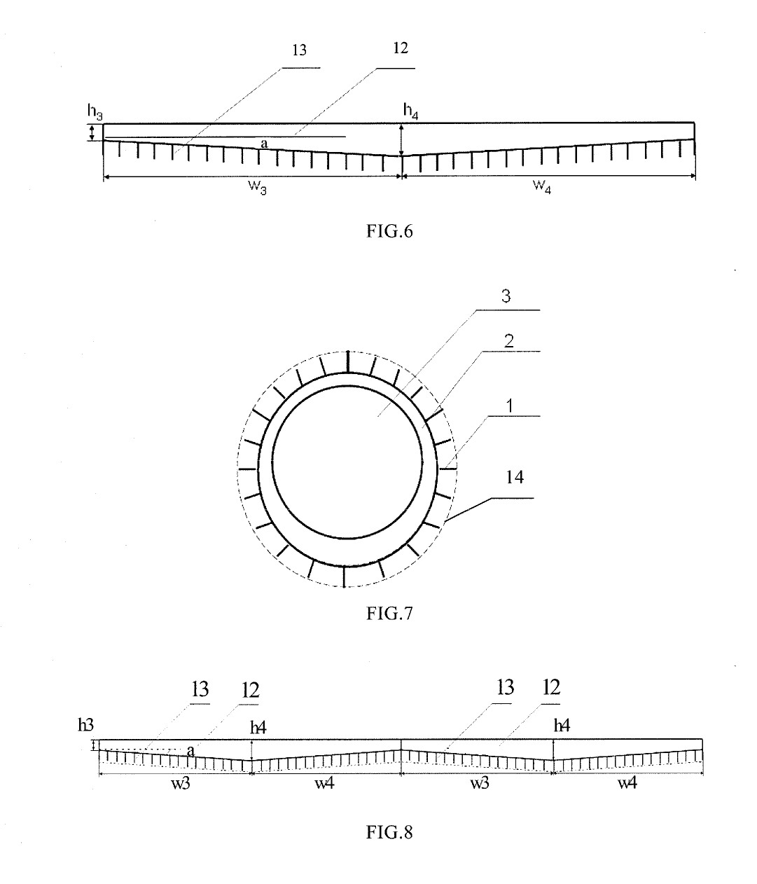

FIG. 6 is a schematic structure view of the third embodiment of a rubbing cloth for the rubbing process on an alignment film of the disclosed technology. As shown in FIG. 6, the rubbing cloth of this embodiment also includes a rubbing base film 12 and rubbing hairness 13.

The rubbing base film 12 is attached on the external surface of a rubbing alignment roller 11, and the rubbing hairness 13 is fixedly arranged on the rubbing base film 12. The tips of all the rubbing hairness 13 on the rubbing base film 12 for contacting with the surface of the alignment film to be rubbed is in a serration along rubbing direction when the rubbing cloth of this embodiment is flattened. The surface in a serration is formed by two inclined surfaces. Moreover, the tips of all the rubbing hairness 13 both on this rubbing base film 12 are continuously connected, and the tips of the rubbing hairness 13 at the two ends of the rubbing base film 12 are continuously connected as well if placed together. The height of the tips of the rubbing hairness 13 of this embodiment is the same as the example shown in the first embodiment, decreasing gradually as well as from the middle to the two sides of the rubbing base film 12, forming a serration; the planes at both sides are inclined with angle of “a,” 0°≦a≦10°.

The structure of the rubbing cloth of this embodiment differs from that of the first embodiment in that the rubbing hairness 13 in this rubbing cloth has a uniform length, but the thickness of the rubbing base film 12 is changed gradually. Particularly, the thickness of the rubbing base film 12 decreases from the middle to the two sides gradually and in a symmetrical shape. The thickness of the rubbing base film 12 changes periodically along the rubbing direction, with n period(s) (n is an integer more than or equal to 1). For example, with reference to FIG. 6, the instance in FIG. 6 shows that the thickness of the rubbing base film 12 of this rubbing cloth includes only one period. This rubbing base film 12 include two sections having a width w3 and w4 respectively, with w3=w4. The rubbing base film 12 of the section w3 and that of the section w4 are in mirror symmetry. In the section w3, the thickness of the rubbing base film 12 increases gradually from left to right, the thickness of the base film at the rightmost side is h4, and the thickness of the base film at the leftmost side is h3. In section w4, the thickness of the rubbing base film 12 decrease from left to right. Due to the uniform height of the rubbing hairness 13, the change of the thickness of the rubbing base film 12 can cause that the height of the tips of the rubbing hairness 13 decreases respectively and gradually from the middle to the two sides symmetrically.

Also, the thickness of the rubbing base film 12 may also increase from the middle to the two sides gradually, which can achieve the purpose of rendering the surface formed by the tips of the rubbing hairness 13 in a serration shape. Furthermore, the difference between the maximum and the minimum of the thickness of the base film is less than or equal to 2 mm, i.e., |h4−h3| is less than or equal to 2 mm. The inclined angle of the surface of the rubbing base film 12 of this embodiment is “a,” where a=arctg(h4−h3)/L, and L is a half of the length of the rubbing base film 12.

FIG. 7 is a schematic structure view of the third embodiment of a rubbing cloth for rubbing process on an alignment film of the disclosed technology. As shown in FIG. 7, the rubbing cloth shown in FIG. 6 is wrapped on a rubbing alignment roller 11 forming an entire circle, and the rubbing base film 12 of the rubbing cloth is attached to the external surface of the rubbing alignment roller 11. The tips of the rubbing hairness 13 of this rubbing cloth contact with the alignment film to be rubbed, have the height that changes continuously, and form one a continuous surface. In the surface 14 formed by the tips of the rubbing hairness, the height of the tips of the adjacent portions of the rubbing hairness 13 is smoothly transitional without a sudden change. Moreover, the tips height of the rubbing hairness 13 of the connected two ends of this rubbing cloth is also transitional smoothly, forming a continuous surface. Thereby, the surface of the entire rubbing alignment roller 11 with the rubbing cloth looks like a smooth surface without a sudden change of the height of the tips of the hairness, which can achieve a relatively good rubbing effect.

The working mechanism of the rubbing cloth of this embodiment is similar to that of the first embodiment and the second embodiment. The rubbing cloth, which rotates with the rubbing alignment roller 11, performs the rubbing treatment on the surface of the alignment film contacting with it. At the position where the thickness of the rubbing base film 12 is greater, the tips of the rubbing hairness 13 is higher and has a greater contact length with the alignment film, which can achieve a relatively great rubbing strength and enhance the anchoring force retaining the liquid crystal. At the position where the thickness of the rubbing base film 12 is smaller, the tips of the rubbing hairness 13 are lower and have a shorter contact length with the alignment film, which can achieve relatively good alignment uniformity. The utilization of the rubbing cloth of the embodiment achieves the purposes of increasing the rubbing strength and enhancing the alignment uniformity simultaneously. Moreover, the surface 14 formed by the tips of the rubbing hairness of this embodiment is a continuous surface, which can rube the alignment film continuously to ensure the uniform distribution of the rubbing strength and the alignment uniformity on the glass substrate.

Furthermore, the thickness of the rubbing base film 12 in this embodiment decreases from the middle to the two sides. It is not limited to this in implementation. For example, the thickness of the rubbing base film 12 may increase from the middle to the two sides gradually, such that the tips of the rubbing hairness 13 become higher respectively and gradually from the middle to the two sides of the rubbing base film 12 symmetrically.

The rubbing cloth of this embodiment for the rubbing processing of alignment film, with the tips of the rubbing hairness as serration along the rubbing direction and the continuous connection of the tips of the rubbing hairness at the two ends of the rubbing base film, avoids decrease of the uniformity of the alignment direction caused by the increase of the contact length of the rubbing hairness with the alignment film, and enhances the rubbing strength and the rubbing uniformity simultaneously. Moreover, the continuous uniformity of the rubbing effect can be ensured by the continuity of the plane formed by the tips, the contrast and the quality of picture can be enhanced and the utilization ratio of the rubbing cloth can be enhanced.

### Embodiment 4

FIG. 8 is a schematic structure view of the fourth embodiment of a rubbing cloth for rubbing process on an alignment film of the disclosed technology. FIG. 9 is a schematic structure view of the fourth embodiment of a rubbing cloth for rubbing process on an alignment film of the disclosed technology.

In this embodiment, also the rubbing hairness 13 has a uniform height, and the thickness of the rubbing base film changes. The embodiment 3 shows an instance in which the thickness of the rubbing base film 12 in the rubbing cloth includes only one change period along the rubbing direction, while in rubbing cloth shown in the FIG. 8 and FIG. 9, the thickness of the rubbing base film 12 includes a plurality of change period along the rubbing direction, for example, two periods in the embodiment, each of which is configured similar to that of the third embodiment.

In the embodiment, it can be seen form FIG. 8 and FIG. 9, the thickness of the rubbing base film 12 changes gradually, such that the surface formed by the tips of the rubbing hairness 13 thereon is continuous. When the rubbing cloth of the embodiment is flattened, the surface formed by the tips of the rubbing hairness 13 presents in a serration. After this rubbing cloth is attached to a rubbing alignment roller 11, the surface 14 formed by the rubbing hairness is smoothly continuous. Moreover, at the connected two ends of the rubbing base film 12, the thickness of the base film 12 is also in gradual change, so as to prevent that the sudden change of the height of the tips of the rubbing hairness 13 from occurring at the connected ends effectively. The surface 14 formed by the tips of the rubbing hairness described above is continuously connected, which can render the effect of rubbing better.

The rubbing cloth of this embodiment for the rubbing processing of the alignment film, with the tips of the rubbing hairness in a serration along the rubbing direction and the continuous connection of the tips of the rubbing hairness at the two ends of the rubbing base film, avoids the decrease of the uniformity of the alignment direction caused by the increase of the contact length of the rubbing hairness with the alignment film, and enhances the rubbing strength and the rubbing uniformity simultaneously. Moreover, the continuous uniformity of the rubbing effect can be ensured by the continuity of the plane formed by the tips, the contrast and the quality of picture can be enhanced and the utilization ratio of the rubbing cloth can be enhanced.

### Embodiment 5

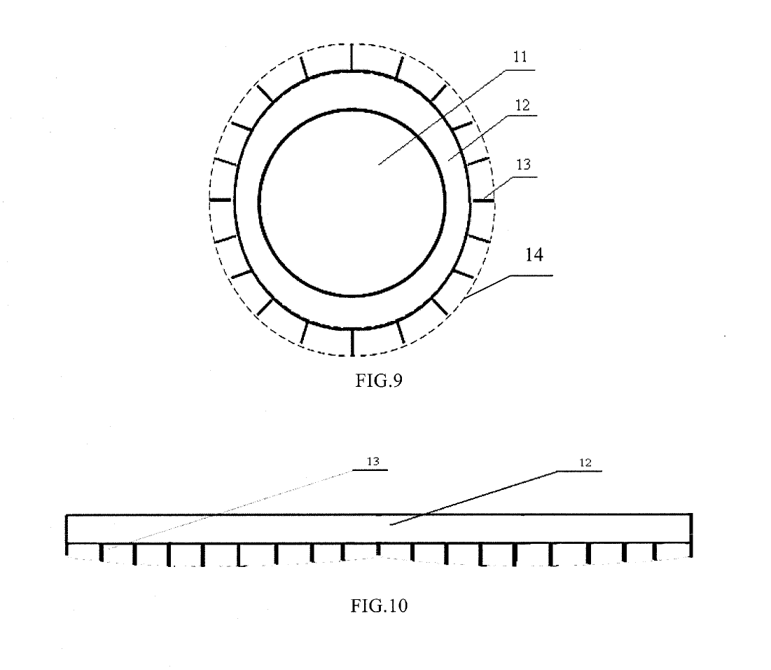

FIG. 10 is a schematic structure view of the fifth embodiment of a rubbing cloth for rubbing process on an alignment film of the disclosed technology. As shown in FIG. 10, after the rubbing cloth of this embodiment is flattened, the surface formed by the tips of the rubbing hairness 13 which presents in a circular arc shape is a smoothly continuous circular arc surface. In this embodiment, the height of the rubbing hairness 13 is in gradual change, i.e., the height of the rubbing hairness 13 changes smoothly and is continuously connected, but not a shape which is irregular and has significant height difference. Moreover, the height between the rubbing hairness 13 at the two connected ends of the rubbing base film 12 is also in gradual change and smoothly transitional, such that after this rubbing cloth is attached to the rubbing alignment roller to form an enclosed circle, the surface formed by tips of the entire rubbing hairness 13 is continuous, preventing a sudden change of the height of the tips from occurring at the connection of the ends of the rubbing cloth.

In this embodiment, the thickness of the rubbing base film 12 is constant with the height of the rubbing hairness 13 changing. It may be understood by those skilled in the art that the case where the height of the rubbing hairness 13 is constant while the thickness of the rubbing base film 12 changes may also work to form the surface in a circular arc shape as shown in FIG. 10. Moreover, this embodiment shows that the height of the rubbing hairness 13 of the rubbing cloth includes two change periods. In implementation, one change period or more change periods may also be used.

The rubbing cloth of the embodiment for the rubbing processing on an alignment film, with arranging the tips of the rubbing hairness as circular arc along the rubbing direction and the continuous connection of the tips of the rubbing hairness at the two ends of the rubbing base film, avoids the decrease of the uniformity of the alignment direction caused by the increase of the contact length of the rubbing hairness with the alignment film, and enhances the rubbing strength and the rubbing uniformity simultaneously. Moreover, the continuous uniformity of the rubbing effect can be ensured by the continuity of the plane formed of the tips, the contrast and the quality of picture can be enhanced and the utilization ratio of the rubbing cloth can be enhanced.

In addition to the instance in which the serration or circular arc shape of the plane formed by the tips of all the rubbing hairness on the rubbing base film is symmetrical with respect to the rubbing hairness of the maximum length in the embodiment described above, the serration or circular arc shape of the plane formed by the tips of all the rubbing hairness on the rubbing base film may be unsymmetrical with respect to the rubbing hairness with of the maximum length in another embodiment.

The embodiment of the disclosed technology being thus described, it will be obvious that the same may be varied in many ways. Such variations are not to be regarded as a departure from the spirit and scope of the disclosed technology, and all such modifications as would be obvious to those skilled in the art are intended to be included within the scope of the following claims.

What is claimed is:

1. A rubbing cloth for rubbing an alignment film, comprising:
a rubbing base film capable of being attached onto an external surface of a rubbing alignment roller; and
rubbing hairness fixedly provided on the rubbing base film;
wherein a surface formed by tips of all the rubbing hairness on the rubbing base film for contacting with a surface of the alignment film is in a serration or circular arc shape along a rubbing direction when the rubbing cloth is flattened; and
both the tips of all the rubbing hairness on the rubbing film and the tips of the hairness at the two ends of the rubbing base film are continuously connected when the rubbing cloth forms an entire circle.

2. The rubbing cloth according to claim 1, wherein the surface formed by the tips of all the rubbing hairness on the rubbing base film changes periodically along the rubbing direction.

3. The rubbing cloth according to claim 2, wherein the surface formed by the tips of all the rubbing hairness on the rubbing base film changes in one period.

4. The rubbing cloth according to claim 3, wherein the tips of the rubbing hairness decreases or increases respectively and gradually from middle to two sides of the rubbing base film symmetrically.

5. The rubbing cloth according to claim 4, wherein an inclined angle formed by the surface of the tips of the rubbing hairness with respect to a bottom surface of the rubbing cloth is less than 10°.

6. The rubbing cloth according to claim 4, wherein the rubbing base film has a uniform thickness and the height of the rubbing hairness increases or decreases gradually from the middle to the two sides.

7. The rubbing cloth according to claim 6, wherein a difference between the maximum value and the minimum value of the height of the rubbing hairness is less than or equal to 2 mm.

8. The rubbing cloth according to claim 4, wherein a thickness of the rubbing base film increases or decreases gradually from the middle to the two sides and the rubbing hairness has a uniform height.

9. The rubbing cloth according to claim 4, wherein the difference between the maximum value and the minimum value of the thickness of the rubbing base film is less than or equal to 2 mm.

10. The rubbing cloth according to claim 1, wherein the serration or circular arc shape of the surface formed by the tips of all the rubbing hairness on the rubbing base film is symmetrical or unsymmetrical with respect to the rubbing hairness with the maximum length.
